(19) United States
(12) Patent Application Publication
(10) Pub. No.: US 2009/0103842 A1
(43) Pub. Date: Apr. 23, 2009

(54) MAINTENANCE FREE AXLE OSCILLATION BEARING

(75) Inventors: Randy Scott Vannorsdel, Dubuque, IA (US); Mark Wayne Stender, Dubuque, IA (US)

Correspondence Address: BAKER & DANIELS LLP, 300 NORTH MERIDIAN STREET, SUITE 2700, INDIANAPOLIS, IN, 46204, US

(73) Assignee: Deere & Company, Moline, IL (US)

(21) Appl. No.: 11/877,354

(22) Filed: Oct. 23, 2007

(51) Int. Cl. F16C 11/00; B60B 35/00; F16C 33/74

(52) U.S. Cl. 384/151; 301/124.1; 384/155

(57) ABSTRACT

There is provided a vehicle having an oscillating solid axle having a maintenance free composite bearing on the oscillating axis.

### FIELD OF THE INVENTION

The invention related to vehicles utilizing an axle that oscillates about an axis perpendicular to the axle. The invention provides a maintenance free bearing for the oscillation axis.

### BACKGROUND OF THE INVENTION

An oscillating solid axle receives its load of the weight of the vehicle and the vehicle contents through the oscillation axis. Thus, although the range of movement about an oscillation axis may be limited to about 30 degrees of a circle, the load on the oscillation axle may be significant. There would be a benefit from a bearing at the axis of oscillation that would withstand severe loading at the oscillation axis and be maintenance free. The instant composite bearing and associated seals meet this need.

### SUMMARY OF THE INVENTION

The present invention offers a maintenance free oscillating axle. Further provided is a maintenance free bearing and seal useful for the axis of an oscillating axle.

### BRIEF DESCRIPTION OF THE DRAWINGS

FIG. 1 is a perspective view of an oscillation vehicle axle.

FIG. 2 is an end view of a vehicle with an oscillating axle.

FIG. 3 is a Section view of an oscillating joint and bearing.

### DESCRIPTION OF THE INVENTION

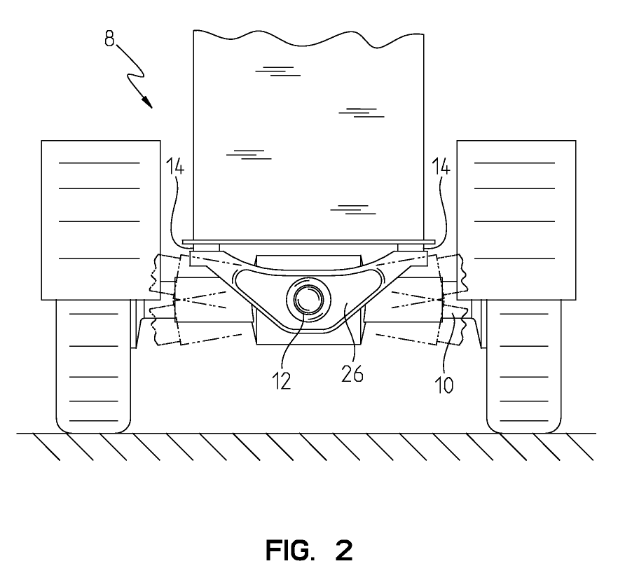

Many slow moving vehicles 8 are equipped with an oscillating or pivoted connection 12 between rigid axles 10 and the vehicle frame or chassis 14: such as fork-lift trucks, loaders; agricultural tractors and the like. The oscillation of the axles permits the axle to tilt when one wheel encounters a depression (or a rise) in the travel surface as illustrated by shadow lines shown on FIG. 2. While the axle tilts, the vehicle frame remains level, within limits, as the axle oscillates to accommodate irregularities in the travel surface.

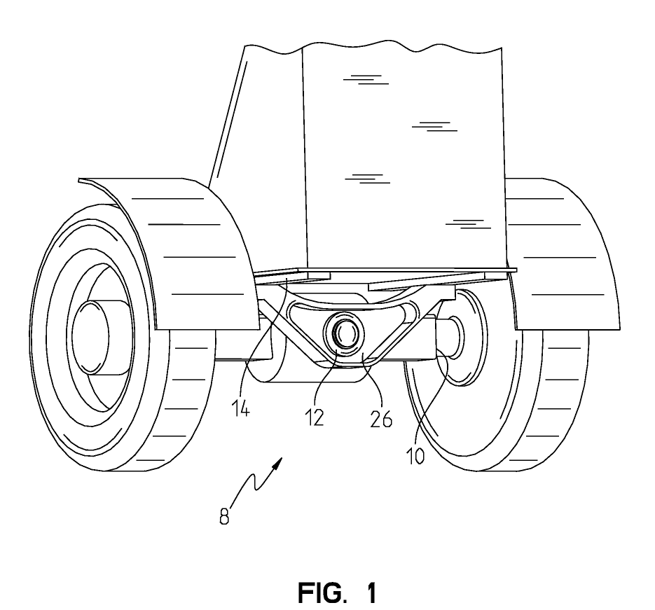

Such vehicles are expected to experience heavy loads, often under sever conditions. Consequently, such vehicles must be constructed to withstand the rigors of their intended use, including the axis of oscillation and the bearing between the frame member and the axle. As is evident from the illustration of the oscillating axle in FIG. 1, the axis of oscillation bears the entire load borne by the axle. Consequently from weight alone, the axis of oscillation must withstand considerable stress. Additionally, such vehicles often operate under severe conditions of abrasive airborne particulate.

Traditionally bearings of the bushing variety of brass or bronze have been used for oscillation axis. Lubrication for such bushings was provided by grease fittings, or self-lubrication bearings such as oil impregnated bronze bushings available under the trademark Oilite™.

The bearings on the axis of oscillation of the prior art required periodic lubrication, and suffered from damage from excessive loads in relation to the bearing size and material. Because of load limitations of the bearing, it became common to increase the surface area of the bearing over the size required for load bearing of the axis and bearing collar to spread the loads over a larger surface area.

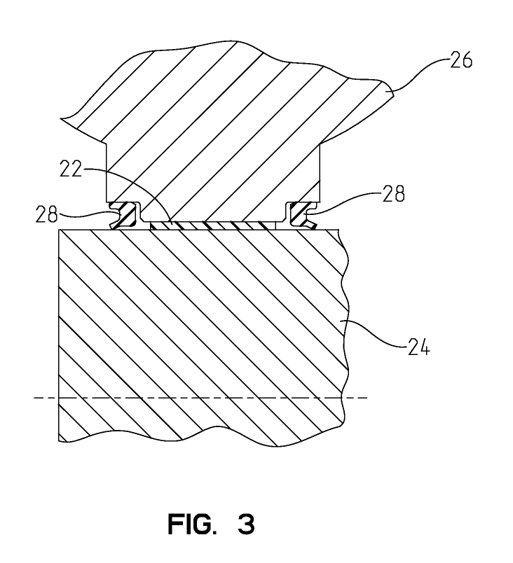

The maintenance free bearing 22 illustrated in FIG. 3 comprises a composite of materials. The bearing 22 is shown between the oscillation shaft 24 and the oscillating member 26. resilient seals 28 separate the bearing from abrasive contaminants.

Typical resilient seals comprise polychloroprene, fluorinated polyethylene, or flexible polyurethane.

Suitable composite bearings include those comprising lead, polytetrafluoroethylene, a particulate of polyarylene sulfide and clay. Other suitable maintenance free bearings may be formed from polytetrafluoroethylene fiber wound with a second fiber selected from polyamide, polyaramid, polyester, and cellulose bonded with a thermosetting resin such as a bisphenol-A epoxide containing from 5 to 25 wt % carbon based on the thermosetting resin.

Suitable commercially available bearings may be obtained from Glacier Garlock: GGB North America P.O. Box 189, 700 MidAtlantic Parkway, Thorofare, N.J. 08086. General description of suitable bearings is available in U.S. Pat. Nos. 4,575,429, and 4,867,889, the entire content thereof being incorporated herein by reference.

In the absence of traditional lubrication in the form of oil or grease in a severe operating environment bearing life is observed to be at least 2 times the life of prior art lubricated bushings.

The utility and benefits described herein as well as modifications and adaptations by those skilled in the art may adapt the invention to specific uses without departing from the spirit and scope of the invention as claimed.

1. A vehicle comprising
an axle oscillating about an axis normal to the axle
wherein the oscillation axis is provided with a self-lubricating composite bearing.

2. The vehicle of claim 1 where the bearing is a composite comprising lead, polytetrafluoroethylene, a particulate of a thermoplastic, and clay.

3. The vehicle of claim 2 where the thermoplastic is polyarlyene sulfide.

4. The vehicle of claim 1 where the bearing is a composite comprising polytetrafluoroethylene, thermosetting resin and from 5 to 25 wt % carbon based on the thermosetting resin.

5. The vehicle of claim 4 wherein the bearing also comprises one or more of a second material selected from polyamide, polyaramid, polyester, and cellulose.

6. The vehicle of claim 5 wherein the polytetrafluoroethylene is in the form of a fiber.

7. The vehicle of claim 6 wherein the second material is in the form of a fiber.

8. The vehicle of claim 1 wherein the greaseless composite bearing is protected by shaped resilient seals.

9. The vehicle of claim 8 wherein the seals are comprised of fluorinated polyethylene, polychloroprene, or polyurethane.
